(19) United States
(12) Patent Application Publication
(10) Pub. No.: US 2003/0030720 A1
(43) Pub. Date: Feb. 13, 2003

(54) Wireless video display apparatus and associated method

(75) Inventor: George T. Hutchings, Doylestown, PA (US)

Correspondence Address: Daniel H. Golub, Morgan, Lewis & Bockius LLP, 1701 Market Street, Philadelphia, PA, 19103-2921, US

(73) Assignee: General Instrument Corporation

(21) Appl. No.: 09/928,056

(22) Filed: Aug. 10, 2001

(51) Int. Cl. H04N 7/14

(52) U.S. Cl. 348/14.02; 455/566

(57) ABSTRACT

A wireless video display apparatus and associated method for displaying an image over a display in response to video information, the wireless video display apparatus comprising a display processing module, a wireless video link, and a wireless video display module. The wireless video link transmits to the wireless video display module processed video information in response to the video information. The wireless display module displays a video image in response to the processed video information received over the wireless video link. In one aspect, a battery provides power to be used by the display.

### FIELD OF THE INVENTION

This invention relates to displays, and more particularly to wireless video displays.

### BACKGROUND OF THE INVENTION

Video display systems are used in homes or office locations in such applications as television, teleconferencing, etc. The complexity of such video display systems varies from a broadcast television to a large-screen display connected to a digital computer. Displays associated with video display systems and computer systems have traditionally been anchored to a single location in a room by a power cord connected to a wall outlet and a separate cable connected to the respective video box or computer. As such, video displays can only be moved a relatively short distance from both the power outlet and the respective video box or computer as limited by the respective lengths of the power cord and the respective video or computer cord.

One prior-art wire-based video display system 100 as shown in FIG. 1 illustrates this limitation. The video display system 100 includes a display processing module 102, a display 104, and a wired-based cable 106 (the component wires of the cable are shown schematically) that is actually hard-wired. The cable 106 transfers the video signals and/or commands between the display processing module 102 and the display 104. The display processing module 102 includes an RF tuner 108, a demodulator/forward error corrector/adaptive equalizer 112, a quadrature phase shift key (QPSK) demodulator 114, a decryption function 116, a Motions Picture Expert Group (MPEG)-Version 2 decoder 120, a microprocessor 122, and an on-screen display character generator 124. Similar wired-based configurations exist where a computer replaces the display processing module 102 and a computer monitor replaces the display 104. In the computer configurations, the display 104 displays graphic images, video images, data, and/or other images.

Infrared wireless links that transfer data between laptop computers and the like are known. The infrared wireless links provide temporary connections that are most suited for low-bandwidth applications such as file transfer. Additionally, the infrared wireless links provide only line-of-sight data transmission. Existing infrared wireless links provide insufficient bandwidth to transmit video signals in a persistent near-real time basis as would be required for video displays.

It would be desirable to provide a wireless video display that can be easily moved throughout a home or an office space, or even temporarily located outdoors. It would also be desirable to provide a technique to format a video data stream to allow for the transfer of video data over a wireless video link so a video image could be viewed on a portable and wireless display.

### SUMMARY OF THE INVENTION

The present invention relates to a wireless video display system apparatus and associated method for displaying an image over a display in response to video information. The wireless video display system comprises a display processing module, a wireless video link, and a wireless video display module. The wireless video link transmits to the wireless video display module processed video information in response to video information. The wireless display module displays a video image in response to the processed video information received over the wireless video link. In one embodiment, a battery provides power to be used by the display.

### BRIEF DESCRIPTION OF THE DRAWINGS

The drawings are incorporated into this disclosure and constitute a part of this specification, and illustrate a preferred embodiment of the invention. Similar elements are provided with the same reference character in the disclosure.

FIG. 1 shows a block diagram of one embodiment of a prior-art wired-based video display system;

FIG. 2 is a block diagram of one embodiment of a wireless video display system of the present invention;

FIG. 3 is an enlarged block diagram of one embodiment of a wireless video display module of the wireless video display system shown in FIG. 2;

FIG. 4, comprising FIGS. 4A and 4B, is a block diagram of one embodiment of a video delivery system including a wireless video display system;

FIG. 5 is a block diagram of an alternate embodiment of a display processing module from that shown in FIG. 2;

FIG. 6 shows one embodiment of method providing information flow through the display processing module of FIGS. 5 and 7;

FIG. 7 shows an embodiment of wireless display module that is configured to interact with the display processing module shown in FIG. 5; and

FIG. 8, comprising FIGS. 8A to 8D show various aspects and contents of an MPEG transport stream.

### DETAILED DESCRIPTION OF THE EMBODIMENT

This disclosure describes multiple embodiments of wireless video display system 200. One of the greatest challenges in providing a wireless video display system 200 is formatting video information in a format sufficient to carry the large amount of data necessary for video, audio, and/or data programs, while in form having a bandwidth that can be conveyed over a wireless video link. In this disclosure, the wireless video link relates to any wireless link that transmits video in addition to data, voice, audio, and any other information that is desired to be transmitted between the display processing module 204 and the wireless video display module 209. This formatting is provided so the bandwidth of the video information does not overwhelm the wireless video link. Some aspects of the wireless video display system relate to compression of the data to be transmitted over the wireless video link. One embodiment of formatting the video information involves providing a display processing module including a packet identifier (PID) filter that passes only information, e.g. packets, relating to channels containing video information selected by the user. This information is then transmitted over the wireless video link. Some aspects of the wireless video display system relate to transmitting only one, or relatively few, video channels from the video information source to a video display so that the total bandwidth of the few video channels is less than the bandwidth of the wireless video link.

Single Selectable Channel Video Configuration

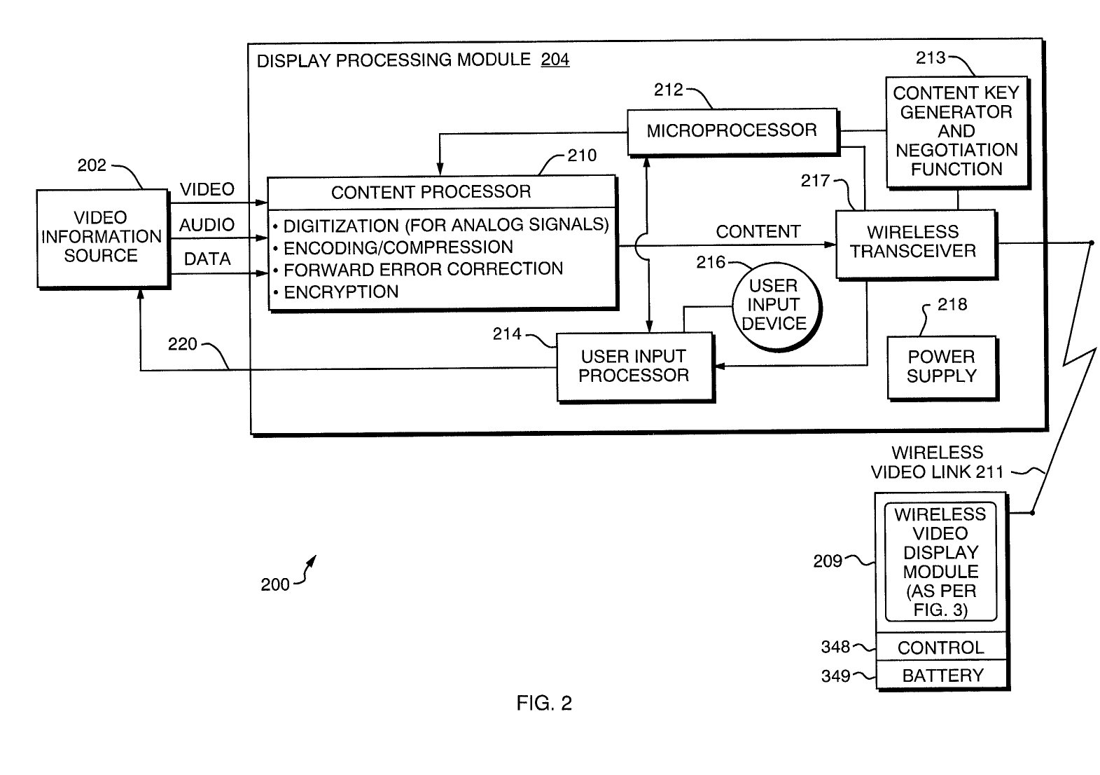

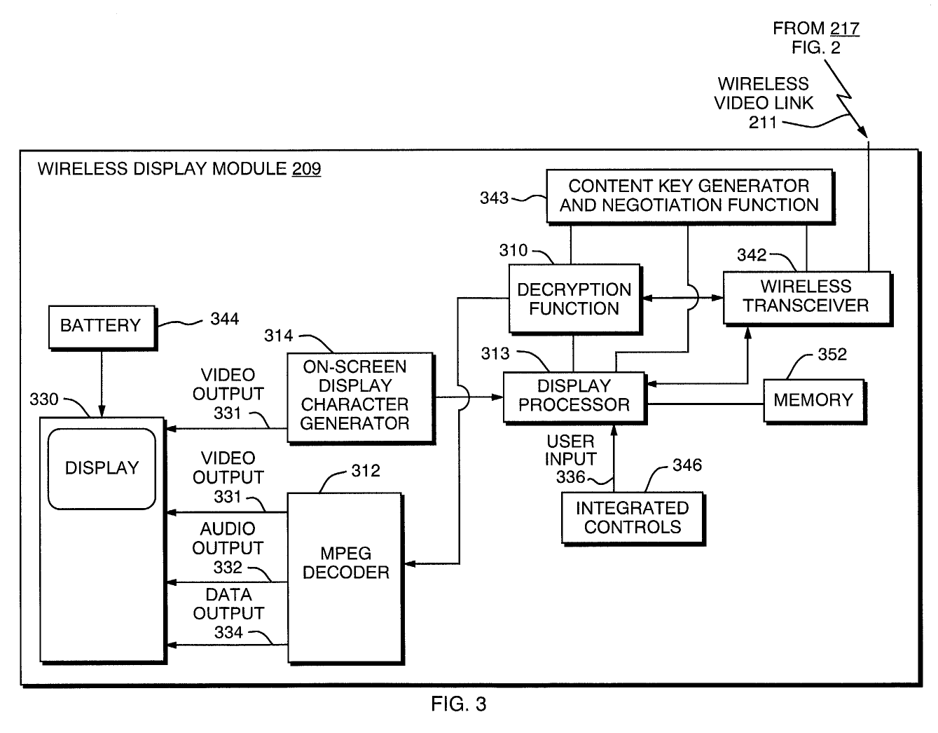

The embodiment of wireless video display system 200 shown in FIG. 2 displays a video image on a display included in a wireless video display module 209. A video stream including compressed video information (typically in the form of packets) is transmitted from a video information source 202 to a wireless video display module 204 via a display processing module 204. The wireless video display system 200 includes the video information source 202, the display processing module 204, a wireless video link 211, and the wireless video display module 209. Video information is provided from a video information source 202, processed within a display processing module 204, and then transmitted over a wireless video link 211 to the wireless video display module 209.

Video information is typically characterized as broadband since a large amount of data is necessary to generate the images on a video display. This disclosure describes how video information can be transported over a relatively narrow bandwidth that defines, e.g., a standardized 802.11(b) wireless video link 211. The wireless video display module 209 receives and displays as a video image the video information transmitted over the wireless video link 211. Different embodiments of the video information source 202 wireless video display module 209, display processing module 204, and wireless video link 211 are each described in this disclosure.

There are multiple embodiments of video information source 202 that generate video information (i.e., video signals). For example, the video information source 202 could be a large scale commercial video or cable service provider that provides video information that is to be processed, transmitted, and eventually displayed as a video image at remote locations over video displays. In another embodiment, one the source provider could provide one, or few, video program stations. Alternatively, the video information source could be a computer in the form of a personal computer, laptop, workstation, or server that transmits data, graphics, or video images that are intended to be remotely viewed over such locations as a personal computer (PC), a laptop, a workstation, or other computer. The embodiments of wireless video display system 200 shown in FIGS. 2 and 3 applies primarily to the latter two embodiments. The wireless video display system 200 can be configured to provide for the display of video or other images on a display screen such as the wireless video display module 209 in any of these embodiments.

The embodiment of display processing module 204 shown in FIG. 2 includes a content processor 210, a microprocessor 212, a content key generator and negotiation function 213, a user-input processor 214, a user-input device 216, a wireless transceiver 217, and a power supply 218. The power supply provides electrical power to the other components of the display processing module 204. The video information source 202 transmits digital information relating to video, audio, and/or data information that will be received by the content processor 210 of the display processing module 204. The content processor 210 provides for digitization only if the video signal transmitted from the video information source 202 is analog. Digital signals received by the content processor 210 from the video information source 202 do not require digitization. The content processor 210 also provides encoding and encryption as necessary for the signals including video information (i.e., video, audio, and/or data) received from the video information source 202. The content processor 210 encrypts signals received from the video information source 202 to provide security to the content of signals transmitted from the wireless transceiver 217 over the wireless video link 211 to the wireless video display module 209. The content processor 210 may also provide for forward error correction of video information transmitted over the wireless video link 211.

The content processor 210 is configured in the embodiment shown in FIG. 2 to allow for user input using user input over the user-input device 216 (to be processed by user-input processor 214). Such user input may be provided to select a particular video, run an application program, interact with a program or application, or provide any of the interactive processes that may be involved between a user and a video or computer system. The microprocessor 212 controls the response of the user-input components 214 and 216 to user input.

The microprocessor 212 controls the general operation, component interaction, and communications between the distinct components 210, 213, 214, 216, and 217 within the display processing module 204. The microprocessor 212, the content processor 210, and the user-input processor 214 may each be configured as any microprocessor, microcomputer, on-circuit chip, or other computer device that can control the operation of one or more different components of the display processing module 204 within the wireless video display system 200. The microprocessor 212 does not have to provide for the additional processing and separate operation associated with the display processing module 204 since the display processing module 204 has its own display processor 313. The microprocessor 212 controls the encoding/encryption process to the wireless transceiver 217. The microprocessor 212 is responsive to user input via the user-input device 216 and the user-input processor 214. Although the microprocessors 212, the content processor 210, and the user-input processor 214 are shown as discrete processors, it is envisioned that certain ones of, or all of, the processors 210, 212, and 214 may share a single actual physical processor.

The user-input device 216 may include a keypad, a mouse, a joystick, or other such device that receives input from the user. The user-input device sends user input to the content processor 210 via the user-input processor 214 and the microprocessor 212 to control the process within the display processing module 204. The user-input device 216 is shown as being integrated in the display processing module 204. It is envisioned that a portion of the user-input device 216 may alternatively be physically located externally to the display processing module 204. The user-input device may even be physically associated with the wireless video display module 209.

The wireless video link 211 negotiates a secure high-speed connection between the display processing module 204 and the wireless video display module 209. In one embodiment, the wireless video link 211 complies with the IEEE 802.11(b) standard. It is envisioned any type of wireless video link that can carry suitable data rate and can be configured to carry formatted video information is within the intended scope of the present invention. The packets carried by the wireless video link 211 are preferably compressed (e.g., by MPEG compression). The display processing module 204 delivers its video information and signal output to the wireless video link 211 in MPEG compressed form, using a valid packet-based wireless data stream that can be processed by the wireless video display module 209.

The integrated controls 346 shown in the embodiment of FIG. 3 may alternatively be located in either the wireless video display module 209 or the display processing module 204 in different embodiments of the wireless video display system 200. The integrated controls 346 include, e.g., cursor and selection functions. For example, a mouse and/or joystick may be included in the wireless video display module 209 whereby a user can, respectively, move a cursor across the screen of the display 330 to provide user input or select an input based on the location of a cursor. The drivers associated with the mouse, joystick, etc., are loaded in the suitable processor. When the cursor is positioned in a desired location, and the user wishes to make a selection, the user can press the selection key that selects a function based on the location of the cursor. Such cursor and selection controls are especially desirable if the display 330 is being used to process data or make user-input selections such as with, for example, a personal computer, laptop, video, and/or video game.

FIG. 2 also shows one embodiment of a wireless video link 211 that extends between the wireless transceiver 217 (shown in the embodiment of display processing module 204 of FIG. 2) and the wireless transceiver 342 (shown in the embodiment of wireless video display module 209 of FIG. 3). The wireless video link 211 may be established so that communications between the wireless transceiver 217 and the wireless transceiver 342 are established via the known media access control (MAC) addresses. Any packet included in the video signals transmitted from the wireless transceiver 217 over the high-speed wireless IEEE 802.11(b) link will contain the MAC address of the wireless transceiver 342, and vice versa. As such, the MAC address of the wireless transceiver 217 will be programmed into the wireless transceiver 342, and the MAC address of the wireless transceiver 342 will be programmed into the wireless transceiver 217.

The wireless transceiver 217 accepts encoded information from the content processor 210. The wireless transceiver applies link-level error correction and modulation (e.g., as per IEEE standard 802.11(b)). The wireless transceiver 217 can also receive user-input control signals from the wireless video display module 209 and deliver the control signals to the user-input processor 214. The user-input received alternatively as a control signal from the wireless video display module 209 or user input transmitted to the user-input device 216 is input to the user-input processor 214 to indicate the desired programming. The user control signal is, accordingly, transmitted from the user-input processor 214 to the microprocessor 212 and/or the appropriate component in the display processing module so that the proper signals and actions can be applied to the content processor 210.

A slightly different method of operation by the wireless video display system 200 would be followed if the display processing module 204 were configured as a computer. Suppose a computer user inputs a command, such as a request to receive video over the Internet. In such instances, the user input would be applied to the user input processor 214 either from the user-input device 216, or as a command signal from the wireless video display module 209 via the wireless video link 211 and the wireless transceiver 217 to the user input processor 214. Under these circumstances, the user input (as provided by a URL request, for example) would be transmitted over line 220 to the video information source 202 that would be configured as a remote computer or server. The remote computer or server would return the requested information such as video, data, images, audio, etc., to the content processor 210. The content processor 210 would then forward the packets received from the video information source 202 over the wireless transceiver 217 to the wireless video display module 209. This embodiment of a method performed by the display processing module 204 by requesting video from a remote video information source 202 involves user input being transmitted to the video information source 202 to control the requested video to be displayed over the display processing module 204.

The content key generator and negotiation function 213 provides for encryption of the video signal transmitted between the display processing module 204 and the content key generator and negotiation function 343 of the embodiment of wireless video display module 209 shown in FIG. 3. One embodiment of the encryption between the two content key generator and the negotiation functions 213, 343 relies on public key encryption. Two known embodiments of public key encryption are Diffie-Helman and RSA, although any type of encryption technique that is applicable to video, data, audio, etc., is within the scope of the present invention. One purpose of the encryption between the two content key generator and negotiation functions 213, 343 is to limit access to video, audio, data, or other information that is being transmitted over the wireless video link 211 by unintended, undesired, or unauthorized third parties that would otherwise be allowed by the third parties intercepting the information being transmitted over the wireless video link 211.

The wireless video display module 209 includes elements that interact to receive a video signal from a video information source 202 over the wireless video link 211 that will be displayed as video over a display 330. The display 330 may be a plasma display, a cathode-ray tube display, a light emitting diode (LED) display, a television, or another such display.

FIG. 3 shows one embodiment of the wireless video display module 209 that interacts with the embodiment of the display processing module 204 shown in FIG. 2. The wireless video display module 209 includes a decryption function 310, an optional MPEG decoder 312 (depending on whether the content processor 210 provides an MPEG compressed data stream), a content key generator and negotiation function 343, a display processor 313, an on-screen display character generator 314, a battery 344, a wireless transceiver 342, integrated controls 346, and the display 330. Certain elements may be located in either the display processing module 204 and/or the wireless video display module 209. For example, the display processing module 204 and/or the wireless video display module 209 may include the user-input device 216.

The elements in the wireless video display module 209 interact to receive a video signal over the wireless video link 211 that will be displayed as a video image over the display 330. The wireless video display module 209 includes the decryption function 310 that decrypts the signal originally encrypted by the by the content processor 210. The memory 352 stores programs and data associated with the general operation of the wireless display module 209 that are used by the display processor 313. In the wireless video display module 209, the decryption function 310 decrypts the signal originally encrypted within the display processing module 204. The decryption function 310 provides the functions necessary for decrypting digital signals and providing clear video signals to subscribers.

The content key generator and negotiation function 343 receives keys (using the public key system) from the content key generator and negotiation function 213 shown in FIG. 2 using such public key or fixed encryption as Diffie-Helman or RSA. In certain embodiments, fixed matching encryption keys may be inserted in the wireless display module and the display processing module 102. The encryption provided by the content key generator and negotiation function 343 limits eavesdropping on the signals transmitted over the wireless video link 211 by unintended third parties.

The integrated controls 346 of the wireless video display module 209 may control the audio and/or video displayed over the display 330. The integrated controls 346 may also allow the user to select a channel carrying a service remotely from the wireless video display module 209. Parts of the integrated controls 346 may be located within the wireless video display system 200 within either the display processing module 204, the wireless video display module 209, or at some other location such as a remote control device. User selections to the integrated controls 346 are converted to control signals that are transmitted from the wireless video display system 200 to the wireless transceiver 342, and are transmitted in wireless form over the wireless video link 211 to the wireless transceiver 217.

The wireless video display module 209 further includes an integrated battery 344. One embodiment of the integrated battery includes a commercially available rechargeable battery. The rechargeable battery in one embodiment may be the type of battery commercially used in laptop computers. The power required to power wireless video display module 209 should be less than that required to power comparable laptop computers since the former requires a smaller memory. A rechargeable/replaceable battery would therefore provide longer viewing than similarly powered laptop computers. The power of the battery is sufficient to generate video, audio, and/or data over the display 330. It is envisioned that both the wireless transceiver 342 and the battery 344 could be encased within a physical casing of the display 330.

The embodiment of wireless video display module 209 shown in FIG. 3 also includes a video output 331, an audio output 332, a data output 334, and a user input 336. Video information is transmitted from the MPEG decoder 312 (in those embodiments that include an MPEG decoder) over the video output 331 to the display 330. The MPEG decoder 312 decompresses the MPEG compressed digital (video+audio+data) signals. MPEG decoders are commercially available and their operation is generally defined by the MPEG protocol that is standardized. The MPEG display outputs an analog signal. The MPEG protocol involves the combined compression techniques for video and audio. Audio and data are transmitted from the MPEG decoder 312 in the display 330 over the audio output 332 and the data output 334, respectively. Upon receipt of the respective video, data, and audio signals over the respective outputs 331, 332, 334, the video, audio, and data are used as appropriate by the display 330 of the wireless video display module 209.

The on-screen display character generator 314 provides various graphics or comments that can be displayed on the display 330. Examples of comments that can be periodically input by the user on the display 330 include, e.g., channel, network selection, and other desired images that are provided by the on-screen display character generator 314. The output of the on-screen display character generator 314 is output via video outline 331 the wireless video display module 209 to be displayed on the display 330.

The wireless video display module 209 associated with the wireless video link 211 configuration would be especially useful if the size and weight of the wireless video display module 209 were made relatively small and light. As such, typical uses of the wireless video display module 209 could easily manually pick up the wireless video display module 209 and move it within a room, between rooms, or about a dwelling or workspace. The wireless video display modules 209 could also be taken outdoors as long as the distance between the wireless transceiver 217 and the wireless transceiver 342 remains within the limits required to maintain an adequate signal over the wireless link 211.

The embodiment of wireless video display system 200 shown in FIGS. 2 and 3 provides for a secure wireless video link 211 established between the wireless video display module 209 and the display processing module 204. The wireless video display module 209 processes the incoming data, decrypts the data, performs MPEG data decompression, and performs presentation control functions with respect to the display 330. The wireless video display system 200 provides for suitable viewing characteristics of whatever video, application program, or other displayed program that is being displayed. The wireless video display system 200 may display the programming service and selected audio over the display. The display 330 provides video and audio controls (contrast, volume, bass, treble, etc.) that may be adjusted by the user.

Since the MPEG decoder 312 is located in the wireless video display module 209 and not the display processing module 204, any MPEG compressed audio/video signal transmitted over the wireless video link 211 between the wireless transceiver 217 and the wireless transceiver 342 will be MPEG compressed to reduce data rate required for the signal content. Similarly, the content key generator and negotiation functions 343 and 213 (shown in FIGS. 3 and 2, respectively) provide for encryption of the information transmitted over the wireless video link 211. As soon as the compressed audio/video signals are received, they are decrypted 310, then decompressed by the MPEG decoder 312 and the video/audio signals will be of sufficient quality to be displayed on the display 330 in the wireless video display module 209.

The embodiment of wireless video display system 200 shown in FIGS. 2, 3, and 5 may provide a variety of viewing options. In one embodiment, the display processing module 204 may be fashioned as a set-top box and the display 330 would be used similarly to present day video television displays. Alternatively, the display processing module 204 may be fashioned as a video card integrated in a computer such as a personal computer or workstation, and the wireless video display module 209 may be used similarly to present-day computers having video cards or teleconferencing systems. It is envisioned that the embodiment of wireless video display system 200 may be configured to provide for a variety of such diverse applications. The above embodiment of wireless video display system 200 shown in FIGS. 2 and 3 provides a somewhat generic version that can be applied to either computer or set-top applications.

Multiple Selectable Channel Video Configuration

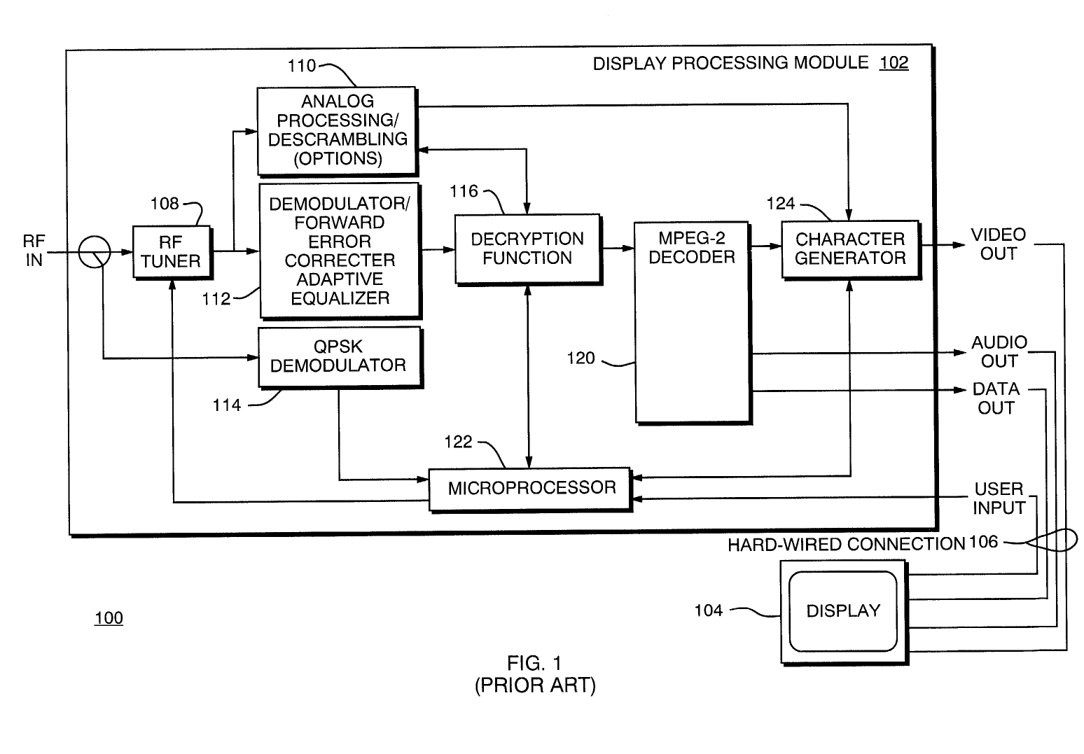

The embodiment of prior-art wire-based video display system 100 shown in FIG. 1 relies on a continuous broadband channel that extends from the video information source (the source that outputs video information to the RF tuner 108) to the display 104. In certain commercial embodiments of prior-art wire-based video display systems, customers can order tens, or even hundreds, of video programs from a service provider. The embodiment of display processing module 204 of FIG. 2 using a wireless video link having a limited bandwidth, such as standardized by 802.11(b), provides one channel (or at the most a few channels) of video information transmitted by a video information source 202 as a video image on a wireless video display module 209. The embodiments of wireless video link 211 are not sufficient to provide such broadband video communications. In commercial settings, alternate embodiments of video information source and display processing module are desired that are capable of, respectively, sending and receiving more than one video channel.

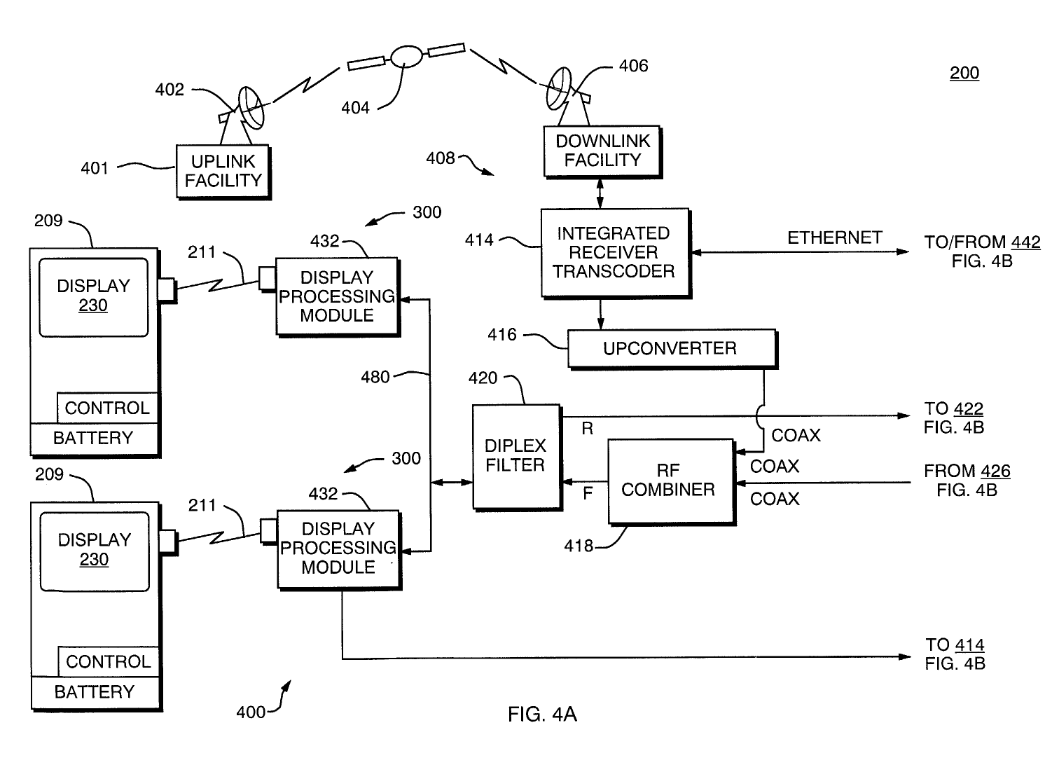

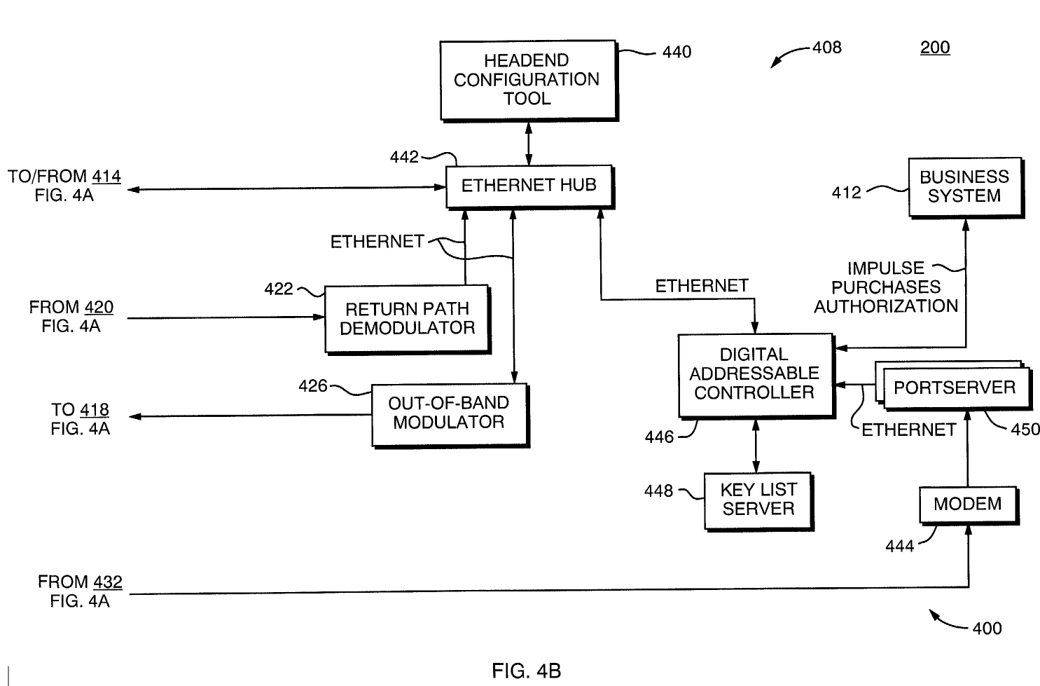

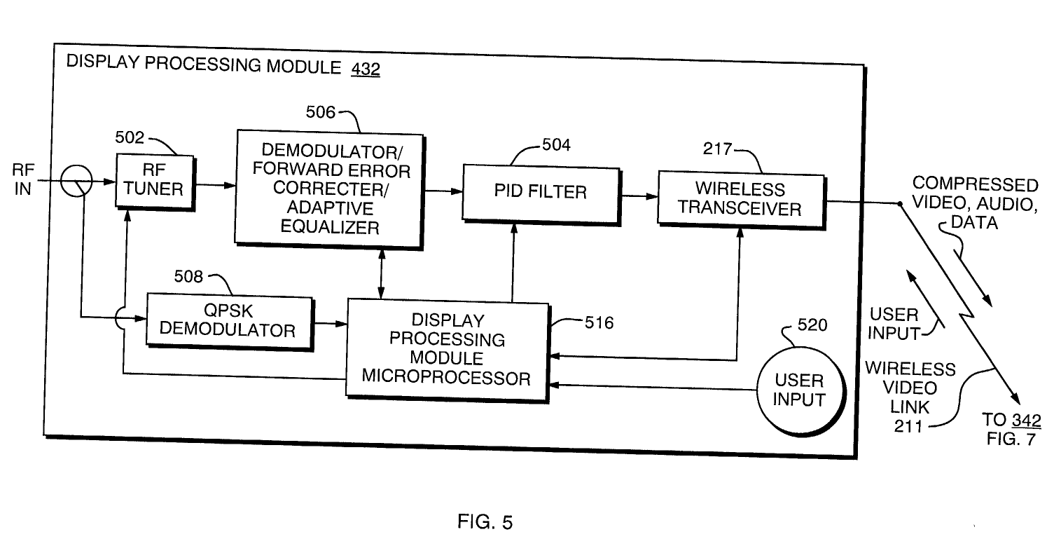

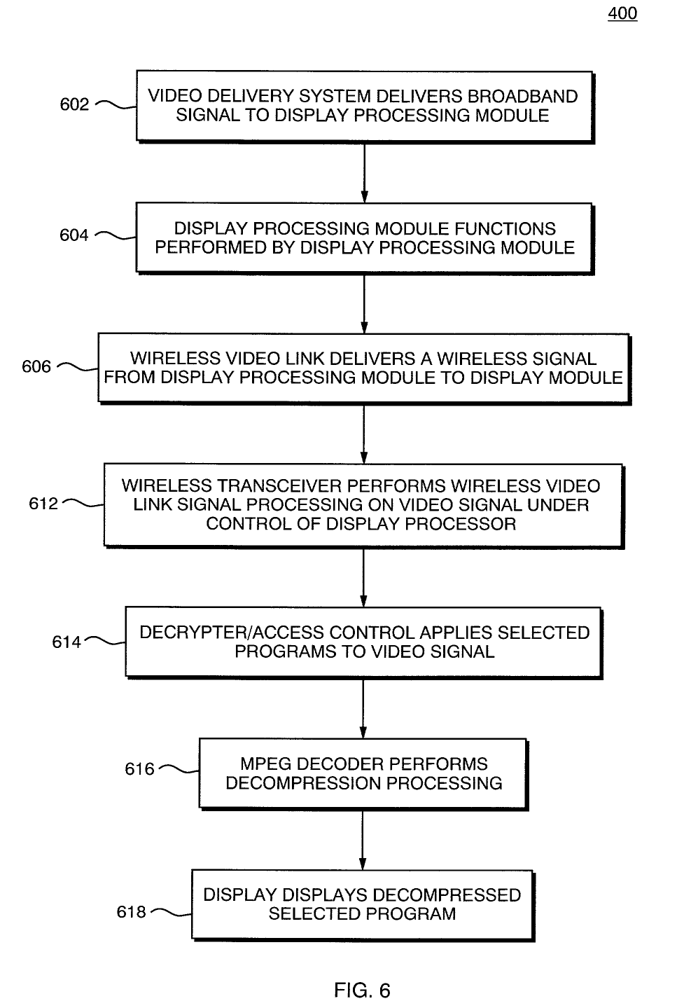

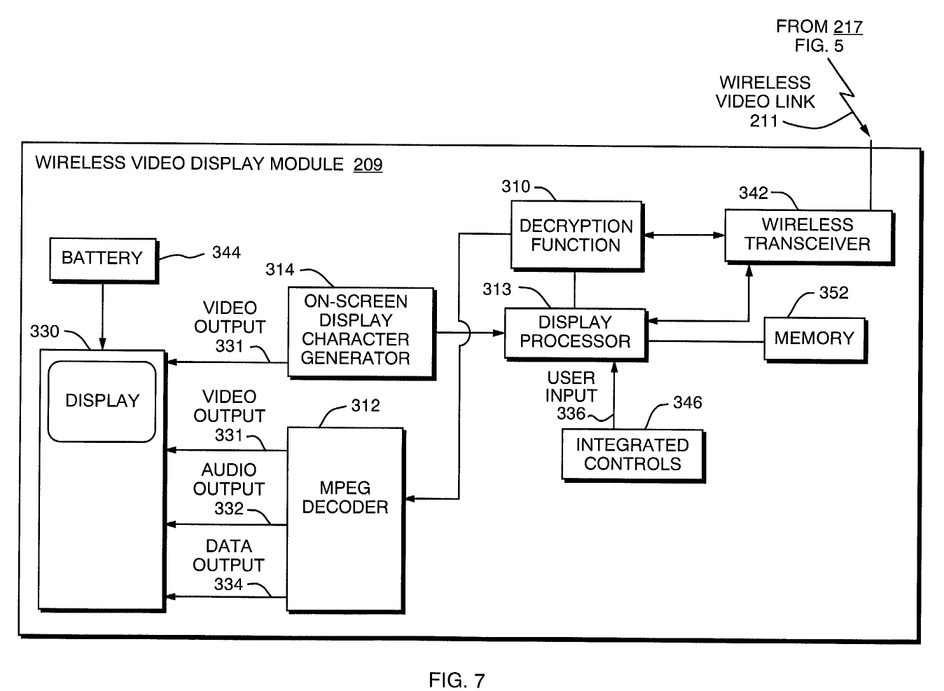

FIG. 4 (comprising FIGS. 4A and 4B) shows an embodiment of a video delivery system 400 that delivers video information to be displayed in the embodiment of display processing module 432 shown in FIG. 5. The video delivery system 400/display processing module 432 combination allows a user to select between a large number (tens or hundreds) of video services (such as HBO™, Showtime™, etc.) over a similar number of channels. The selected video information is formatted to allow transmission of the selected video information over a wireless video link according to the, for example, 802.11(b) standard or other wireless communication protocol.

The display processing module can provide a similar number of video channels to its customers as the prior-art wire-based video display system 100 over a wireless video link 211 to a wireless video display system 200. The video delivery system 400 may be viewed as one embodiment of video information source 202 shown in FIG. 2. The video delivery system 400 provides a video signal to be received by, and displayed by, the wireless video display system 200. The wireless video display system 200 includes a display processing module 432 connected to a wireless video display module 209 via a wireless video link 211. The wireless video display module 209 includes a display 330 that displays video (and perhaps data) and projects audio. The display 330 may be a plasma display, a cathode-ray tube display, a light emitting dioxide (LED) display, a television, or another such display.

The FIG. 4 embodiment of video delivery system 400 is satellite-based. The structure and apparatus of an embodiment of the wireless video display module 209 that connects to the display processing module 432 using a wireless video link 211 is also described. The video delivery system 400 comprises an uplink facility 402, a satellite 404, a downlink facility 406, a headend 408, a digital addressable controller (DAC) 446, a key list server 448, a modem 444, a portserver 450, and a business system 412. In the video delivery system 400, programming (including a variety of services over multiple channels) is provided at the uplink facility 402. Video, audio, and data signals are transmitted from the uplink 402 via an array of satellites 404 to the downlink 406 and the headend 408. Multiple headends 408 are located around the world and are positioned to provide for reception of video, audio, or data signals that can be accessed by a large number of customers. Video signals received the downlink 406 are generally weak in addition to being encoded. Therefore the signals require amplification to provide for direct disbursement of video, audio, and other services to the wireless video display system 200.

Each headend 408 includes an integrated receiver transcoder (IRT) 414, an upconverter 416, a radio frequency (RF) combiner 418, a diplex filter 420, a cable plant 480, a return path demodulator 422, a headend configuration tool 440, an Ethernet hub 442, and an out-of-band modulator (OM) 426. Both the video signals transmitted from the uplink/facility 402 to the integrated receiver transcoder 414 and the video signals transmitted from the integrated receiver transcoder 414 to the display processing module 432 are encoded (typically using different encoding) to limit nonpaying individuals from accessing free service. Such video signals transmit services provided by service providers that offer such services as Home Box Office (HBO™), Cable News Network (CNN™), etc. The integrated receiver transcoder 414 receives quadrature phase shift-key (QPSK) modulated input from the downlink 406, and transcodes the signal to a 64 quadrature amplitude modulation (QAM) signal. Quadrature amplitude modulation is a double sideband data modulation technique used to convert digital program information for suitable delivery over the in-band frequencies of cable television systems. Quadrature amplitude modulation also permits an increase in the amount of data that may be carried by that signal. The integrated receiver transcoder 414 also decrypts the satellite signal, and then re-encrypts the signal using a different encryption and using a different signal encryption scheme. The re-encrypted signal may be amplified in the integrated receiver transcoder 414 (in addition to at the upconvertor 416) to provide sufficient strength to the video signal for cable distribution.

In one embodiment, the upconverter 416 receives a 64 quadrature amplitude modulation modulated input, and converts it to a sufficiently strong RF signal that can be transmitted via the RF combiner 418, the diplex filter 420, the cable plant 480, and the display processing module 432 to the wireless video display module 209. The RF combiner 418 combines multiple input streams from headends 408 onto a single RF output. The diplex filter 420 is a combination high-low bandpass filter that allows only those signals within a prescribed frequency bandwidth to pass to the wireless video display system 200. The filter allows signals to pass either in a forward or return direction (indicated respectively by the F and the R in FIG. 4A) depending on the frequency of the signal. Therefore, signals transmitted from the RF combiner 418 to the display processing module 432 will be transmitted within a set of forward frequency bands. Any signal having a frequency corresponding to the forward frequency band will be allowed to pass via the diplex filter 420 via the cable plant 480 to the display processing module 432, but will be limited from passing along the return path R. By comparison, signals passing from the display processing module 432 to the return path demodulator 422 in the return direction as indicated by the letter R will be transmitted within a set of return frequency bands. Any signal passing through the cable plant 480 to the diplex filter 420 that has a frequency corresponding to the return frequency band will be allowed to pass to the return path demodulator 422 in the return direction R.

The video delivery system 400 is capable of delivering video service to the wireless video display system 200 including both the display processing module 432 and the wireless video display module 209. The out-of-band modulator 426 converts the controlled data digital stream to an RF output signal that is transmitted to customers using the wireless video display system 200. The return path demodulator 422 receives, demodulates, and processes return signals from the display processing module 432 via the cable plant 480 and the diplex filter 420 to the Ethernet hub 442 delivery to the DAC 446. The headend configuration tool 440, that is typically arranged as a PC, interfaces with the Ethernet hub 442 so a person can adjust the configuration and settings of certain components in the headend.

The business (or billing) system 412 is a computer system that includes a memory/program forming a database of subscribers, their services, and their respective set top box configurations. The business system 412 generates subscriber bills and from time to time is physically connected to DAC 446, which in turn is connected to a customer set-top box. Certain embodiments of digital addressable controller 446 authorize display processing modules 432 for service. The key list server 448 verifies the digital addressable controller 446 and acts to ensure system security. The key list server 448 is used to deliver encrypted keys to headends 408.

The embodiment of display processing module 432 shown in FIG. 5 is configured to interact with the embodiment of wireless video display module 209 shown in FIG. 7. The wireless video display module 209 shown in FIG. 7 includes a decryption function 310, an MPEG decoder 312, a display processor 313, an on-screen display character generator 314, a battery 344, a wireless transceiver 342, integrated controls 346, and the display 330. The components of the embodiment of wireless video display module 209 shown in FIG. 7 are similar to the corresponding components of the embodiment of wireless video display module 209 shown in FIG. 3, except that there is no content key generator and negotiation function 343 in the embodiment of display processing module 432 shown in FIG. 5 (as there was in the embodiment shown in FIG. 3) since the encryption function is provided for by IRT 414.

The wireless video link (for example the 802.11(b)) is configured to carry less video information than traditionally conveyed over the hard-wired connection shown in the prior-art embodiment of display processing module 102 shown in FIG. 1. The embodiment of display processing module 432 shown in FIG. 5 uses the combination of the RF tuner 502 and PID filter 504 shown in FIG. 5 to select only those video channels, audio channels, data channels, and other information channels selected by the user. Only information related to the selected video channel and/or program is transmitted across the wireless video link 211. This limits the amount of video information transferred from the display processing module 204 to the wireless video display module 209 across the wireless video link 211 in those embodiments shown in FIGS. 5 and 7 to only the service selected by the user reduces the bandwidth applied to the wireless video link 211 to an amount that can be conveyed using existing wireless (e.g., 802.11(b)) technology.

There are three signals related to the display processing module 432 that are now described. The signals may take different forms at different locations along their paths. For example, a signal may be encoded, compressed, decompressed, etc., in a manner that changes the content of the signals. The three signals are referred to as a video content signal, an authorization signal, and an impulse-program signal. The video content signal includes video, data, audio, and other information transmitted from the uplink 402 to the display processing module 432 and the wireless video display module 209. This video content signal is initially transmitted from the uplink 402 to the downlink 406 in the headend 408.

All of the programming services (e.g., HBO™, CNN™, etc.) that each one of the users/display processing modules can subscribe to over the wireless display system (that is provided by the system provider) will be transmitted to each one of the display processing modules 432 over the video content signal. As such, each display processing module that subscribes to a particular service provider will likely receive identical video content signals. The display processing modules thereupon operate to allow only those portions of the video content signal that each specific user is authorized to view to pass through the display processing module 432 to the wireless video display module 209. The video content signal may contain audio, video, data, and/or other information that is typically encrypted and/or encoded. From the downlink 406, the video content signal is transmitted via the integrated receiver transcoder 414 via the upconverter 416, which changes the frequency of the transport multiplex. The signal carrying the transport multiplex continues to the RF combiner 418, which combines with other like signals containing transport multiplexes, and delivers to the diplex filter 420, (and the cable plant 480, the display providing module 432, and 211) through the cable plant 480 to the wireless video display module 209.

Within the display processing module 432, the video content information is processed to generate the video and/or audio signals that are further provided to the wireless video display module 209 and display 330. The wireless video display module 209 is electronically configured such that the video signal is supplied from the display processing module 432 to the wireless video display module 209. The wireless video display module 209 may include a display 330 such as a television display, a flat panel display, a plasma display, a cathode-ray tube display, a light emitting diode (LED) display, etc.

The second signal that the display processing module 432 is associated with is referred to as an authorization signal. The authorization signal indicates those programs that each user has paid for and is entitled to view. The authorization signal is based on a user ordering a service from a cable provider. The business system 412 relates to business aspects of the cable provider. The user typically physically telephones, mails, or in some other manner interacts with the cable provider physically located at the business system 412 to order a specific service. Service personnel employed by the cable provider, and located at the business system 412, input orders to the digital addressable controller 446, which determines the authorization for each user. Once the authorization for each user is determined, the digital addressable controller 446 outputs an authorization signal that is eventually received at each participating display processing module 432.

The authorization signal includes a periodically repeating indication for each display processing module 432 of the services each display processing module 432 is authorized from the services included in the video content information. The authorization signal is initially generated by the digital addressable controller 446 and is thereupon transmitted via the Ethernet hub 442 to the out-of-band modulator 426. The out-of-band modulator 426 modulates the authorization signal and transmits the signal to the RF combiner 418. The RF combiner 418 combines the authorization signal with other signals (e.g., other authorization signals and/or other video content signals), and forwards the combined signals via the diplex filter 420 via the cable plant 480 to the display processing module 432. The display processing module 432, based on the authorized service indicated by the authorization signal relating to that particular user, allows filtering using the received video content signal to provide only those programs that the user is authorized to access.

The third type of signal that the display processing module 432 is associated with is referred to as an impulse-program signal. Impulse-program signals relate to programs that are ordered shortly before they air, or become available, by a user over the display processing module 432. Examples of impulse-programs include sporting events and recently released movies. Movies, video games, Internet service, etc., ordered by hotel guests are another example of services ordered using impulse-program signals. Impulse-programs may be ordered using the display processing module 432. There are two possible paths for impulse-program signals. The first possible path for ordering impulse-program signals is from the display processing module 432 directly via a modem 444 and the portserver 450 to the digital addressable controller 446. The second possible path for impulse-program signals is from display processing module 432 via the cable plant 480 to the diplex filter 420, to the return path demodulator 422 and the Ethernet hub 442 to the digital addressable controller 446. Regardless of which path is followed for the impulse-program signal, the authorization of the user is changed in response to the digital addressable controller receiving the impulse-program signal. The newly generated authorization signals will reflect the changes for that user corresponding to the impulse-program signal.

Another embodiment of display processing module 204 different from that shown in the embodiment of FIG. 2 is the display processing module 432 embodiment shown in FIG. 5. The display processing module 432 includes an RF tuner 502, a quadrature amplitude modulation demodulator/forward error corrector/adaptive equalizer 506, a PID filter 504, a quadrature phase shift key demodulator 508, a display processing module microprocessor 516, a user input 520, and a wireless transceiver 217. The RF tuner 502 may be directed to a specific frequency to acquire a specific MPEG transport stream. Subsequently, the PID filter 504 is used to provide selective filtering of the video, audio, and data provided by the video information source processor to the display processing module 204 over the wireless video link. For example, if the user selects a different channel (each channel carrying a distinct service) as input to the user-input processor 214 and the microprocessor 212, the different channel results in the microprocessor changing the settings of the RF tuner 502 (if the selected program is assigned to a different RF frequency).

The display processing module 432 communicates to the wireless video display module 209 shown in FIG. 3 (as described above) via the wireless video link 211. There are several components that may be located in the display processing module 432 and/or the wireless video display module 209. For example, in one embodiment of the wireless video display system 200, both the display processing module 432 and the wireless video display module 209 are configured to include a tuner and a processor so either the display processing module and the wireless video display module may provide these functions.

The display processing module 432 receives the video content signal from the cable plant 480, and processes and converts the video content signal into a form that can be transmitted over the wireless video link 211 to the wireless video display module 209. The RF tuner 502 selects the frequency of the signal to be received by the display processing module 432, and thereby selects a channel that will be displayed on the display 330 of the wireless video display module 209. The demodulator/forward error corrector/adaptive equalizer 506 includes a demodulator portion, a forward error corrector portion, and an adaptive equalizer portion, the output is MPEG compressed format.

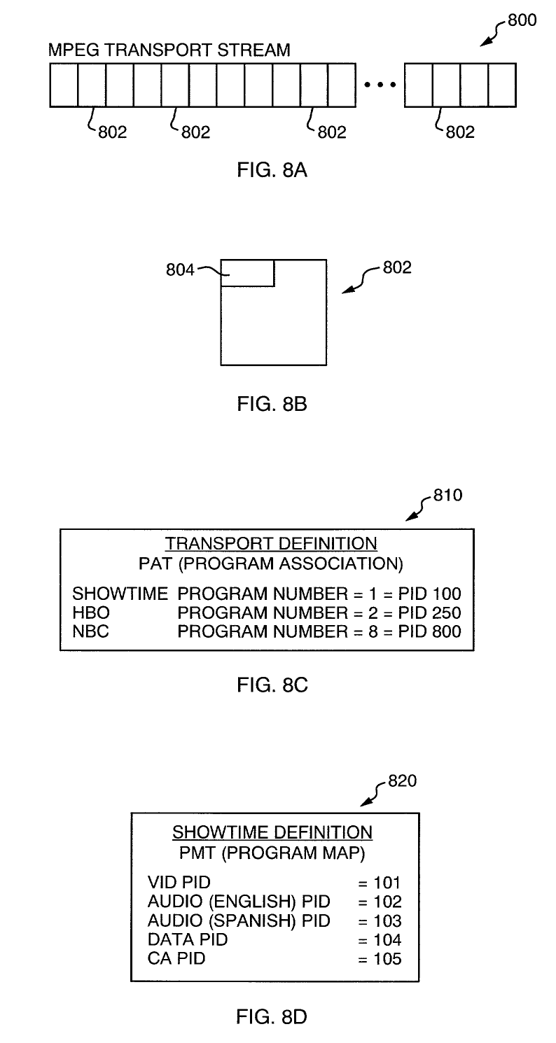

The operation of the PID filter 504 and the MPEG transport stream 800 to limit the bandwidth transmitted over the wireless video link 211 is now described. FIG. 8A shows one embodiment of the MPEG transport stream 800 that carries information relating to a PID table. The transport stream is filtered by the PID filter 504 shown in FIG. 5 to pass only packets corresponding to the selected program PIDS from a large variety of video channels, that are to be transmitted over the wireless video link 211. Each MPEG transport stream 800 is formed from a plurality of packets 802. One exemplary MPEG packet 802 shown in FIG. 8A includes a packet header 804 as shown in FIG. 8B.

MPEG is a standard describing video/audio compression, and MPEG-2 is the standard that applied the MPEG standard to such systems as set-top boxes. MPEG-2 transmits its transport stream data in packets of 188 bytes each. A transport stream is a series of transport stream packets 802, including standard tables that define the content of the transport stream. One embodiment of system information packets is included in the MPEG transport stream 800. The system information packets indicate to the display processing module 432 information about the format of the transmission along with information such as multiple language selections, program guide information and other types of information about the transport stream.

The first part of the system information packets, of which a program association table (PAT) 810 shown in FIG. 8C and a program map table (PMT) 820 shown in FIG. 8D are examples. FIGS. 8A and 8D indicates how the information relating to the PMT 820 is interpreted. The PAT table 810 may be considered as a table of contents of an MPEG transport stream 800. The PAT table 810 carries program specific information (PSI) and is built when an MPEG transport stream 800 is created at the multiplexor, which interleaves packets from the numerous PID streams to form the transport stream. The PAT table 810 contains multiplex definition information, is typically transmitted on PID 0000, and contains a list of PMT 820 that are included as part of the MPEG transport stream 800. The PAT tables 810 provide an index of services that are carried by the MPEG transport stream 800 (e.g., HBO™, NBC™, etc.), and the PAT tables 810 are inserted in the MPEG transport stream 800 several times per second.

The PAT tables completely define the content available in the MPEG transport stream 800. A 13-bit field in the transport packet header contains a Packet Identifier (PID) that uniquely identifies each stream and distinguish between packets containing different types of information. The PID indicates to the wireless display module 209 what to do with each packet. PIDs are a component of the MPEG specification. Aspects of the PID are used by the PID filter 504 to limit the bandwidth of the video data that is transmitted over the wireless video link 211. A PID number is assigned to each MPEG transport stream packet to identify the data string to which it belongs. The PID number is assigned in the packet header, and all packets from the same string have the same PID number. PID0 provides multiplex definition information for the transport multiplex via the PMT. PID1 and selected other PID point to a data stream containing access control information.

FIG. 8D shows one example of a PID table 820 that includes, e.g., the “ShowTime™” program. An MPEG transport stream may contain one or more independent, individual programs, such as individual television channels or television programs, where each individual program can have its own time base, and each stream making up an individual program has its own PID. Each separate individual program has one or more elementary streams that generally share a common time base. In a given MPEG transport stream 800, all packets belonging to a given elementary stream will have the same PID. Packets in another elementary stream will have another PID. For example, the elementary stream containing the coded video data for a network television program may be assigned a PID of “801”; the elementary stream containing the associated audio data for that program may be assigned a PID of “802” in English and “803” in Spanish, the elementary stream containing the associated data for that program may be assigned a PID of “804”, etc. The PID filter 504 shown in FIG. 5 can act as a demultiplexer to select all data for a given elementary stream simply by accepting only packets with the correct PID. Data for an entire program can be selected using the appropriate PIDs included in the MPEG transport stream for video, audio, data, and any other type of information.

The PID filter 504 passes only those packets associated with a desired service from the demodulator/forward error corrector/adaptive equalizer 506 to the wireless transceiver 217. Therefore, assume that a user selects a prescribed video service such as, e.g., HBO™ or CNN™. The PID filter 504 will initially view the PID table that provides the PID table values for the user-selected video service. The PID table corresponding to the selected video service will include the PID addresses associated with the video, audio, data, etc. corresponding to the user selected program. The wireless transceiver 217 then transmits only the video, audio, and data to the wireless transceiver 342 in the wireless video display module 209 via the wireless video link 211 that corresponds to the user selected program.

The display processing module microprocessor 516 controls, regulates, and provides user input to the other components in the display processing module 432. The display processor 313 controls, regulates, and provides user input to the other components in the wireless video display module 209. In one embodiment, the display processing module microprocessor 516 receives information from the user input 520, such as a channel selection, contrast selection, etc. The display processing module microprocessor 516 and the display processor 313 may each be configured as any microprocessor, microcomputer, on-circuit chip, or other computer device that can control the operation of the different components of the respective display processing module 432 or the wireless video display system 200.

FIG. 6 shows one embodiment of the information flow through the display processing module. The video delivery system 400, shown in FIG. 4 delivers a broadband signal to the display processing module 204 (or display processing module 432) in step 602. The display processing module 204 functions applied at step 604 are performed by the embodiment of display processing module 204 shown in FIG. 2, and by the embodiment of display processing module 432 shown in FIG. 5. The decryption and the MPEG decoding functions that are performed in prior art display processing modules are not performed in the display processing module of the present invention, but instead are performed in the wireless video display module 209. In the embodiment of display processing module 432 shown in FIG. 5, the PID filter 504 filters only those video programs requested by the user to transmit over the wireless video link. In other words, the PID filter 504 formats the data to a bandwidth that can be transmitted over the wireless video link 211. In step 606, the wireless video link 211 (in association with the associated wireless transceivers 217 and 342) delivers a wireless signal including the selected program from display processing module 204 to the wireless video display module 209.

In step 612 of FIG. 6, the wireless transceiver 342 performs wireless video link signal processing. The wireless video link signal processing includes amplifying the wireless video signal to a level suitable for processing within the wireless video display module 209, signal filtering, etc. The decryption function 310 shown in FIG. 3 applies selective programs to the video signal in step 614. The selective programs are stored in a memory 352 within the wireless video display module 209. The MPEG decoder 312 of the wireless video display module 209 performs MPEG processing in step 616 to yield a decompressed selective program signal. The display 330 of the wireless video display module 209 displays the decompressed selected video program in step 618.

While the principles of the invention have been described above in connection with the specific apparatus and associated method, it is to be clearly understood that this description is made only by way of example and not as a limitation on the scope of the invention.

What is claimed is:

1. A wireless video display system for displaying a video image in response to video information generated by a content source, the wireless video display system comprising:
a display processing module for generating processed video information in response to the video information;
a wireless video display module including a display; and
a wireless video link for transmitting the processed video information from the display processing module to the wireless video display module, wherein the wireless video display module displays the video image over the display in response to the processed video information.

2. The wireless video display system of claim 1, further comprising a battery for providing power to the display.

3. The wireless video display system of claim 1, wherein the video information is compressed video information, further comprising a decompression device for generating decompressed video information, wherein the wireless video display displays the video image in response to the decompressed video information.

4. The wireless video display system of claim 1, wherein the video information is compressed using Motions Picture Expert Group (MPEG) compression techniques.

5. The wireless video display system of claim 1, wherein the wireless video link complies with the IEEE 802.11(b) standard.

6. The wireless video display system of claim 1, wherein the wireless video link provides a secure connection, in which data being transferred is encrypted, over which the video information is received by the wireless video link.

7. The wireless video display system of claim 1, further comprising a decryption device for decrypting the video signal.

8. The wireless video display system of claim 1, further comprising audio controls.

9. The wireless video display system of claim 1, further comprising display controls.

10. The wireless video display system of claim 1, further comprising cursor functions.

11. The wireless video display system of claim 1, further comprising selection functions.

12. The wireless video display system of claim 1, wherein the display processing module negotiates the wireless video link as a high speed wireless video link.

13. The wireless video display system of claim 1, wherein the wireless video display module transmits channel tuning commands to the display processing module.

14. The wireless video display system of claim 1, wherein the video information generated by the content source has too large a bandwidth to be transmitted over the wireless video link, and the display processing module formats the processed video information to allow it to be transmitted over a wireless video link.

15. The wireless video display system of claim 14, wherein the display processing module further comprising a packet identifier (PID) filter that filters out information not selected by the user from the processed video information that is transmitted over the wireless video link.

16. A method comprising:
formatting video information in a form that can be transmitted over a wireless video link.

17. The method of claim 16, wherein video information generated by the content source has too large of a bandwidth to be transmitted over the wireless video link, and the display processing module formats the processed video information to allow it to be transmitted over a wireless video link.

18. The method of claim 17, further comprising a packet identifier (PID) filter that filters out information not selected by the user from the processed video information that is transmitted over the wireless video link.

19. A wireless video display system, further comprising:
A display processing module to format video information to be transmitted as processed video information over a wireless video link, the display processing module further comprising:
A content processor that processes the video information into processed video information, the content processor encodes, encrypts, and forward error corrects the video information.

20. The wireless video display system of claim 19, further comprising a user-input device that controls the processing of the video information into processed video information.

21. The wireless video display system of claim 19, further comprising a wireless video display module, wherein the display processing module transmits processed video information to the wireless video display module over the wireless video link.

22. The wireless video display system of claim 21, wherein the display processing module farther comprises a first content key generator and negotiation function and the wireless video display module comprises a second content key generator and negotiation function, and wherein the first content key generator and negotiation function and the second content key generator and negotiation function are used to provide a secure connection over the wireless video link.

23. The wireless video display system of claim 21, wherein the display processing module further comprises a data decompression device.

24. The wireless video display system of claim 21, wherein the display processing module further comprises a decryption function.

25. A wireless video display system, further comprising:
A display processing module to format video information containing a large number of channels of video information to be transmitted as processed video information over a wireless video link, the display processing module further comprising:
A tuner that filters the number of channels in the processed video information relative to the number of channels in the video information; and
A PID filter that selects the video information to be filtered to produce the processed video information.

26. The wireless video display system of claim 25, further comprising a user-input device that controls the processing of the video information into processed video information.

27. The wireless video display system of claim 25, further comprising a wireless video display module, wherein the display processing module transmits processed video information to the wireless video display module over the wireless video link.

28. The wireless video display system of claim 25, wherein the display processing module further comprises a data decompression device.

29. The wireless video display system of claim 25, wherein the display processing module further comprises a decryption function.
